(19) United States
(12) Patent Application Publication
(10) Pub. No.: US 2023/0130360 A1
(43) Pub. Date: Apr. 27, 2023

(54) ASSISTANCE DEVICE

(71) Applicant: FANUC CORPORATION, Yamanashi (JP)

(72) Inventor: Takashi MIYOSHI, Yamanashi (JP)

(73) Assignee: FANUC CORPORATION, Yamanashi (JP)

(21) Appl. No.: 17/759,899

(22) PCT Filed: Feb. 1, 2021
(86) PCT No.: PCT/JP2021/003483

§ 371 Date: Aug. 1, 2022

(30) Foreign Application Priority Data
Feb. 6, 2020 (JP) 2020-018620

(51) Int. Cl. G05B 19/4069

(52) U.S. Cl. CPC G05B 19/4069; G05B 2219/35311

(57) ABSTRACT

Provided is an assistance device which can reduce a work load when executing a simulation. The assistance device is provided with: a detection unit which detects a change in a simulation condition for executing a simulation; a working relationship information storage unit which stores working relationship information indicating an influence of a change in a simulation condition on a working simulation result by an industrial machine; a determination unit which determines, from among a plurality of forms of simulation, a form of simulation in which the change in the simulation condition influences the result of the working simulation, on the basis of the change in the simulation condition and the working relationship information; and a selection unit which selects, on the basis of the determination result from the determination unit, the simulation form in which the change in the simulation condition influences the working simulation result.

### TECHNICAL FIELD

The present invention relates to an assistance device.

### BACKGROUND ART

Conventionally, various forms of simulation exist to simulate machining with industrial machines including computerized numerical control (CNC) machine tools, for example. An operator using such an industrial machine implements a simulation as necessary. Simulations to simulate machining with such industrial machines are known (for example, see Japanese Unexamined Patent Application, Publication No. 2019-174967).

Patent Document 1: Japanese Unexamined Patent Application, Publication No. 2019-174967

### DISCLOSURE OF THE INVENTION

### Problems to be Solved by the Invention

However, the operator may sometimes face difficulties in selecting an appropriate simulation due to a change in a machining condition or setting in an industrial machine, for example. In this case, a problem arises in that both workload and machining time of the operator increase. Therefore, it has been desired to reduce a workload when implementing a simulation.

### Means for Solving the Problems

An assistance device according to an aspect of the present disclosure is an assistance device configured to assist implementation of a plurality of forms of simulation relating to an industrial machine. The assistance device includes: a detection unit configured to detect a change in a simulation condition for executing a simulation; a machining relationship information storage unit configured to store machining relationship information indicating an influence of the change in the simulation condition on a result of a simulation for machining by the industrial machine; a determination unit configured to determine, from among the plurality of forms of simulation, a form of simulation in which the change in the simulation condition influences a result of the simulation for the machining, based on the change in the simulation condition and the machining relationship information; and a selection unit configured to select, based on the result of determination by the determination unit, the form of simulation in which the change in the simulation condition influences the result of the simulation for the machining.

### Effects of the Invention

According to the present invention, it is possible to reduce a workload when implementing a simulation.

### BRIEF DESCRIPTION OF THE DRAWINGS

FIG. 1 is a view illustrating an outline of an assistance device according to the present embodiment;

FIG. 2 is a view illustrating an example of simulations that the assistance device determines; and

FIG. 3 is a flowchart illustrating processing that the assistance device performs.

### PREFERRED MODE FOR CARRYING OUT THE INVENTION

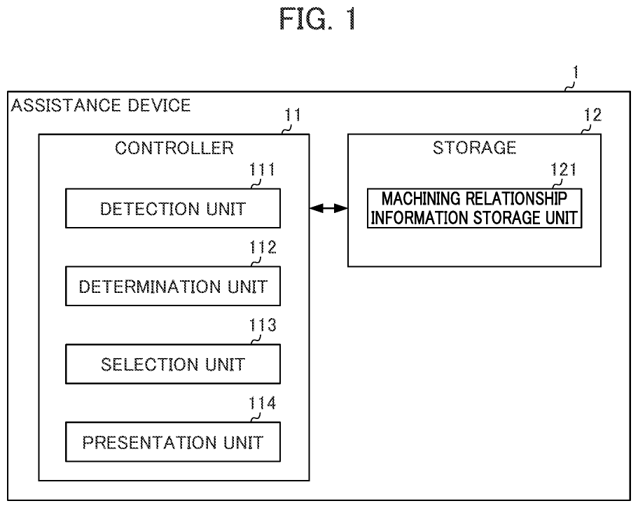

An example of an embodiment of the present invention will now be described herein. FIG. 1 is a view illustrating an outline of an assistance device 1 according to the present embodiment. The assistance device 1 is configured to assist the execution of a plurality of forms of simulation relating to an industrial machine such as a CNC machine tool. The assistance device 1 may be incorporated into an industrial machine or may be a computer device that is independent from an industrial machine.

An industrial machine such as a CNC machine tool has various simulation functions (verification functions) relating to machining and operation. The industrial machine executes the simulation functions as necessary. As illustrated in FIG. 1, the assistance device 1 includes a controller 11 and a storage 12.

The controller 11 represents a processor such as a central processing unit (CPU), and is configured to execute programs stored in the storage 23 to function as a detection unit 111, a determination unit 112, a selection unit 113, and a presentation unit 114.

The storage 12 represents a storage device including, for example, a read only memory (ROM) storing an operating system (OS), application programs, and other programs, a random access memory (RAM), and a hard disk drive and a solid state drive (SSD) storing various other information. Furthermore, the storage 12 includes a machining relationship information storage unit 121. The machining relationship information storage unit 121 is configured to store machining relationship information indicating an influence of a change in a simulation condition on a result of a simulation for machining by the industrial machine.

Note that, when the assistance device 1 is a computer device that is independent from the industrial machine, the assistance device 1 includes a communication unit (not shown) configured to communicate in a wired or wireless manner with the industrial machine via a network. The communication unit includes a processor, a connector, and an electric circuit, for example, for executing communications. The communication unit is configured to perform predetermined processing on communication signals received from the industrial machine to acquire data, and to input the acquired data into the controller 11. Furthermore, the communication unit performs predetermined processing on data that is inputted from the controller 11 to generate communication signals, and to send the generated communication signals to the industrial machine.

The detection unit 111 is configured to detect a change in a simulation condition for executing a simulation. Specifically, the detection unit 111 detects a change in a simulation condition when executing and/or storing a machining program for the industrial machine. For example, when the industrial machine is a CNC, and the assistance device 1 is built into the CNC or is communicably coupled to the CNC, the detection unit 111 detects a change in a simulation condition when executing and/or storing a machining program for the CNC.

Note herein that a change in a simulation condition includes a change in a parameter set value for the industrial machine or a change in a machining program for the industrial machine. Specifically, a change in a parameter set value for the industrial machine or a change in a machining program for the industrial machine includes, for example, a change in a cutting parameter value for the CNC, a change in a program when high-speed feeding takes place, a change in a program relating to cutting feed operation, and a change in a parameter relating to the posture of a tool.

The determination unit 112 is configured to determine, from among the plurality of forms of simulation, a form of simulation in which the change in the simulation condition influences a result of the simulation for the machining, based on the change in the simulation condition detected by the detection unit 111 and the machining relationship information stored in the machining relationship information storage unit 121.

Note herein that the plurality of forms of simulation include at least one selected from a cutting simulation, a collision prevention simulation, and a machining time estimation simulation.

Furthermore, an influence on a result of a simulation for machining by the industrial machine includes at least one selected from a machining time for a workpiece undergoing machining by the industrial machine, the quality of a worked surface of the workpiece, and the positional relationship of a moving part of the industrial machine.

Furthermore, the machining relationship information storage unit 121 stores, as the machining relationship information, the content of the change in the simulation condition and the form of simulation in an associated manner.

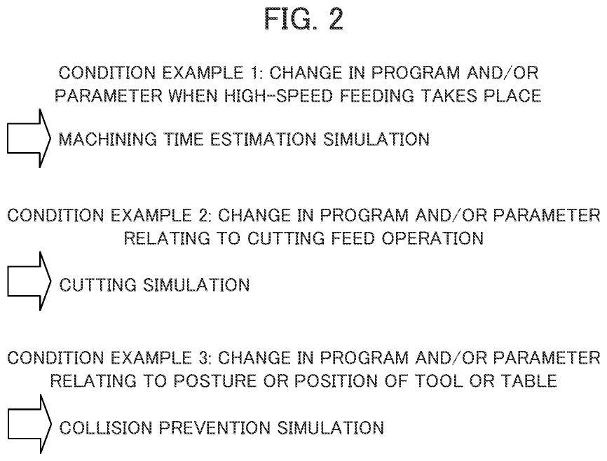

FIG. 2 is a view illustrating an example of a simulation of machining by the CNC machine tool, which the assistance device 1 determines. In Condition Example 1, a change in a simulation condition represents a change in a program and/or a parameter when high-speed feeding takes place. When there is a change in a program and/or a parameter when high-speed feeding takes place, the determination unit 112 determines the machining time estimation simulation that is associated with the change in the program and/or the parameter when high-speed feeding takes place in the machining relationship information storage unit 121 as a form of simulation in which a change in a simulation condition influences a result of a simulation for machining.

Furthermore, the cutting simulation and the collision prevention simulation are not associated with the change in the program and/or the parameter when high-speed feeding takes place in the machining relationship information storage unit 121. Therefore, the determination unit 112 determines the cutting simulation and the collision prevention simulation as forms of simulation in which a change in a simulation condition does not influence a result of the simulation for the machining.

In Condition Example 2, a change in a simulation condition represents a change in a program and/or a parameter relating to the cutting feed operation. When there is a change in a program and/or a parameter relating to the cutting feed operation, the determination unit 112 determines the cutting simulation that is associated with the change in the program and/or the parameter relating to the cutting feed operation in the machining relationship information storage unit 121 as a form of simulation in which a change in a simulation condition influences a result of a simulation for machining.

Furthermore, the machining time estimation simulation and the collision prevention simulation are not associated with the change in the program and/or the parameter relating to the cutting feed operation in the machining relationship information storage unit 121. Therefore, the determination unit 112 determines the machining time estimation simulation and the collision prevention simulation as forms of simulation in which a change in a simulation condition does not influence a result of the simulation for the machining.

In Condition Example 3, a change in a simulation condition represents a change in a program and/or a parameter relating to the posture and position of a tool or table. When there is a change in a program and/or a parameter relating to the posture and position of a tool or table, the determination unit 112 determines the collision prevention simulation that is associated with the change in the program and/or the parameter relating to the posture and position of the tool or table in the machining relationship information storage unit 121 as a form of simulation in which a change in a simulation condition influences a result of a simulation for machining.

Furthermore, the machining time estimation simulation and the cutting simulation are not associated with the change in the program and/or the parameter relating to the posture and position of the tool or table in the machining relationship information storage unit 121. Therefore, the determination unit 112 determines the machining time estimation simulation and the cutting simulation as forms of simulation in which a change in a simulation condition does not influence a result of the simulation for the machining.

Now back to FIG. 1. The selection unit 113 is configured to select the form of simulation appropriate for the machining by the industrial machine based on the result of determination by the determination unit 112. For example, when the determination unit 112 determines the machining time estimation simulation as a form of simulation in which a change in a simulation condition influences a result of a simulation for machining, the selection unit 113 selects the machining time estimation simulation as a form of simulation appropriate for the machining by the industrial machine.

Note that, as for the selection unit 113, when the determination unit 112 determines a plurality of simulations as forms of simulation in which a change in a simulation condition influences a result of a simulation for machining, the selection unit 113 selects the plurality of simulations as forms of simulation appropriate for the machining by the industrial machine.

The presentation unit 114 is configured to present the form of simulation that the selection unit 113 has selected to the industrial machine. For example, the presentation unit 114 causes a display unit of the CNC to display the name of the form of simulation that the selection unit 113 has selected. Thereby, the operator of the industrial machine is able to know the form of simulation appropriate for the machining by the industrial machine.

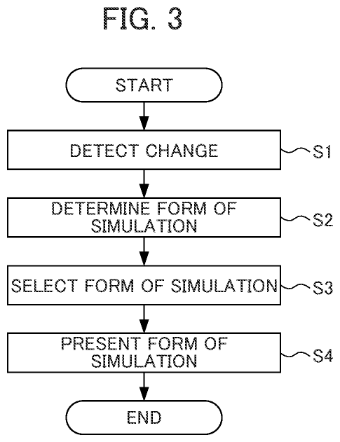

FIG. 3 is a flowchart illustrating processing that the assistance device 1 performs. At Step S1, the detection unit 111 detects a change in a simulation condition when executing and/or storing a machining program for the industrial machine.

At Step S2, the determination unit 112 determines, from among the plurality of forms of simulation, a form of simulation in which a change in a simulation condition influences a result of a simulation for machining, based on the change in the simulation condition, which is detected by the detection unit 111, and the machining relationship information, which is stored in the machining relationship information storage unit 121.

At Step S3, the selection unit 113 selects the form of simulation appropriate for the machining by the industrial machine based on the result of determination by the determination unit 112. At Step S4, the form of simulation selected by the selection unit 113 is presented to the industrial machine.

According to the present embodiment, the assistance device 1 includes the detection unit 111 configured to detect a change in a simulation condition for executing a simulation; the machining relationship information storage unit 121 configured to store machining relationship information indicating an influence of the change in the simulation condition on a result of a simulation for machining by the industrial machine; the determination unit 112 configured to determine, from among a plurality of forms of simulation, a form of simulation in which the change in the simulation condition influences a result of the simulation for the machining, based on the change in the simulation condition and the machining relationship information; and the selection unit 113 configured to select, based on the result of determination by the determination unit 112, the form of simulation in which the change in the simulation condition influences the result of the simulation for the machining.

Thereby, for the operator, it is not necessary to execute all forms of simulation each time there is a change in a simulation condition, making it unnecessary to further determine which simulation should be executed. Therefore, the assistance device 1 according to the present embodiment makes it possible to reduce a workload when implementing a simulation.

Furthermore, the detection unit 111 detects a change in a simulation condition when executing and/or storing a machining program for the industrial machine. Thereby, the assistance device 1 makes it possible to select a form of simulation appropriate for a machining program when using the machining program.

Furthermore, a change in a simulation condition includes a change in a parameter set value for the industrial machine or a change in a machining program for the industrial machine. Thereby, the assistance device 1 makes it possible to appropriately determine a form of simulation in which a change in a simulation condition influences a result of a simulation for machining.

Furthermore, the plurality of forms of simulation include at least one selected from the cutting simulation, the collision prevention simulation, and the machining time estimation simulation. Thereby, the assistance device 1 makes it possible to select an appropriate simulation from among these forms of simulation.

Furthermore, an influence on a result of a simulation for machining by the industrial machine includes at least one selected from a machining time for a workpiece, the quality of a worked surface of the workpiece, and the positional relationship of a moving part of the industrial machine. Thereby, the assistance device 1 makes it possible to appropriately select a form of simulation that influences a result of a simulation for machining by the industrial machine.

Furthermore, the machining relationship information storage unit 121 stores, as the machining relationship information, the content of the change in the simulation condition and the form of simulation in an associated manner. Thereby, the assistance device 1 makes it possible to determine a form of simulation in which a change in a simulation condition influences a result of a simulation for machining.

Note that the machining relationship information storage unit 121 may store, as the machining relationship information, for example, the content of a change in a simulation condition, an influence on a result of a simulation for machining by the industrial machine, and a form of simulation in an associated manner. Thereby, the assistance device 1 makes it possible to take into account an influence on a result of a simulation for machining by the industrial machine to determine a form of simulation in which a change in a simulation condition influences a result of the simulation for the machining.

Furthermore, the determination unit 112 may determine, for each change in a simulation condition when there are a plurality of changes in simulation conditions, a form of simulation in which the change in the simulation condition influences a result of a simulation for machining.

In this case, the selection unit 113 selects the form of simulation determined per change in a simulation condition. Furthermore, the selection unit 113 may select an identical form of simulation in a duplicated manner.

Although the embodiment of the present invention has been described, the present invention is not limited to the embodiment described above. The effects described in the present embodiment correspond to most preferable effects that are derived from the present invention, and that are merely listed. The effects of the present invention are not however limited to the effects described in the present embodiment.

### EXPLANATION OF REFERENCE NUMERALS

1 Assistance device
11 Controller
12 Storage
111 Detection unit
112 Determination unit
113 Selection unit
114 Presentation unit
121 Machining relationship information storage unit

1. An assistance device configured to assist implementation of a plurality of forms of simulation relating to an industrial machine, the assistance device comprising:
a detection unit configured to detect a change in a simulation condition for executing a simulation;
a machining relationship information storage unit configured to store machining relationship information indicating an influence of the change in the simulation condition on a result of a simulation for machining by the industrial machine;
a determination unit configured to determine, from among the plurality of forms of simulation, a form of simulation in which the change in the simulation condition influences a result of the simulation for the machining, based on the change in the simulation condition and the machining relationship information; and
a selection unit configured to select, based on the result of determination by the determination unit, the form of simulation in which the change in the simulation condition influences the result of the simulation for the machining.

2. The assistance device according to claim 1, wherein the detection unit detects the change in the simulation condition when executing and/or storing a machining program for the industrial machine.

3. The assistance device according to claim 1, wherein the change in the simulation condition includes a change in a parameter set value for the industrial machine or a change in a machining program for the industrial machine.

4. The assistance device according to claim 1, wherein the plurality of forms of simulation include at least one selected from a cutting simulation, a collision prevention simulation, and a machining time estimation simulation.

5. The assistance device according to claim 1, wherein the influence on the result of the simulation for the machining by the industrial machine includes at least one selected from a machining time for a workpiece, quality of a worked surface of the workpiece, and positional relationship of a moving part of the industrial machine.

6. The assistance device according to claim 1, wherein the machining relationship information storage unit stores, as the machining relationship information, content of the change in the simulation condition and the form of the simulation in an associated manner.
